(19) United States
(12) Patent Application Publication
(10) Pub. No.: US 2006/0290142 A1
(43) Pub. Date: Dec. 28, 2006

(54) Door closer apparatus for vehicle

(75) Inventors: Akira Tani, Anjo-shi (JP); Ken Sakakibara, Kariya-shi (JP)

Correspondence Address: BUCHANAN, INGERSOLL & ROONEY PC, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 11/475,208

(22) Filed: Jun. 27, 2006

(30) Foreign Application Priority Data
Jun. 27, 2005 (JP) 2005-186189

(51) Int. Cl. E05C 3/06

(52) U.S. Cl. 292/201

(57) ABSTRACT

A door closer apparatus for a vehicle includes a striker provided at one of a vehicle body and a door, a latch provided at the other one of the vehicle body and the door, the latch being engageable with the striker, a motor configured to apply a driving power to the latch, the motor being configured to rotate the latch in engaged with the striker in a closing direction by applying the driving power, so as to control the door to a closed state relative to the vehicle body, a rotation member provided between the motor and the latch for transmitting the driving power to the latch, a lever member integrally rotated with the latch, and a closing member integrally formed with the rotation member, the closing member being configured to push the lever member in a first direction for rotating the latch in the closing direction.

This application is based on and claims priority under 35 U.S.C. § 119 to Japanese Patent Application 2005-186189, filed on Jun. 27, 2005, the entire content of which is incorporated herein by reference.

### FIELD OF THE INVENTION

The present invention relates to a door closer apparatus for a vehicle. More particularly, the present invention pertains to a door closer apparatus for a vehicle, which turns a door into a closed state relative to a vehicle body by rotating a latch engaged with a striker on a receipt of a driving power.

### BACKGROUND

A known door closer apparatus is disclosed in US2002-117862A1. The disclosed door closer apparatus includes a striker, a latch, a latch lever, a motor, a rotation member, and a closing member. The striker is provided at a vehicle body, the latch is provided at a door and is engageable with the striker, the latch lever is fixed to the latch and is integrally rotated with the latch, the motor generates a driving power, the rotation member is rotated on a receipt of the driving power generated by the motor, and the closing member is operated on a receipt of the driving power from the rotation member for rotating the latch lever. The rotation member is provided with a pin. The rotation member engages with the closing member through the pin. The closing member is biased by means of a spring so as to place the closing member at an initial position.

When the latch is engaged with the striker by a predetermined amount, the motor is applied with an electric power and the motor generates the driving power. Then, the rotation member is rotated on a receipt of the driving power generated by the motor. The rotation member engages with the closing member through the pin and operates the closing member against a biasing force of the spring. Because of an operation of the closing member, the latch ever is rotated and the latch, which is fixed to the latch lever, is thereby rotated in a condition where the latch lever is engaged with the striker. Accordingly, the door comes into a closed state relative to the vehicle body.

According to the door closer apparatus disclosed in US2002-117862A1, the rotation member is engaged with the closing member through the pin. With such configuration, the driving power is transmitted from the rotation member to the closing member through the pin. Therefore, a loss of the driving power (i.e., a driving power depletion) may occasionally occur at an engaging site of the pin and the closing member because of, for example, a tilting of the pin relative to the rotation member. Further, because the closing member is configured to operate against the biasing power of the spring, a certain loss of the driving power may occasionally occur.

A need thus exists to provide a door closer apparatus, which improves transmission efficiency of the driving power.

### SUMMARY OF THE INVENTION

According to an aspect of the present invention, a door closer apparatus for a vehicle includes a striker provided at one of a vehicle body and a door, a latch provided at the other one of the vehicle body and the door, the latch being engageable with the striker, a motor configured to apply a driving power to the latch, the motor being configured to rotate the latch in engaged with the striker in a closing direction by applying the driving power, so as to control the door to a closed state relative to the vehicle body, a rotation member provided between the motor and the latch for transmitting the driving power to the latch, a lever member integrally rotated with the latch, and a closing member integrally formed with the rotation member, the closing member being configured to push the lever member in a first direction for rotating the latch in the closing direction.

### BRIEF DESCRIPTION OF THE DRAWINGS

The foregoing and additional features and characteristics of the present invention will become more apparent from the following detailed description considered with reference to the accompanying drawings, wherein:

FIG. 1 is a perspective view illustrating a rear portion of a vehicle 1 provided with a door closer apparatus 10 of the present invention;

FIG. 2 is a schematic view illustrating the door closer apparatus 10 and a marginal structure thereof (a sectional view taken along line II-II of FIG. 1);

FIG. 3 is a front view of the door closer apparatus 10, viewed from a direction of an arrow B in FIG. 2;

FIG. 4 is an exploded perspective view of main components of the door closer apparatus 10;

FIG. 5A is a front view of a driven gear 42.

FIG. 5B is a plan view of the driven gear 42, viewed from a direction of an arrow E in FIG. 5A,

FIG. 6 is a sectional view taken along line VI-VI of FIG. 3.

FIG. 7A is a view for explaining a closing operation in a condition where each component of a closing and releasing mechanism and a lock mechanism is placed at an initial position;

FIG. 7B is a view for explaining the closing operation in a condition where the each component of the closing and releasing mechanism and the lock mechanism is placed at a half-latched position;

FIG. 7C is a view for explaining the closing operation in a condition where the each component of the closing and releasing mechanism and the lock mechanism is placed at a full-latched position;

FIG. 8A is a schematic view illustrating an opened state of a door 2 relative to a body 3;

FIG. 8B is a schematic view illustrating a half closed state of the door 2 relative to the body 3;

FIG. 8C is a schematic view illustrating a closed state of the door 2 relative to the body;

FIG. 9 is a view for explaining an irregular operation during the closing operation;

FIG. 10A is a view for explaining a releasing operation in a condition where each component of the closing and releasing mechanism and the lock mechanism is placed at an initial position;

FIG. 10B is a view for explaining the releasing operation in a condition where each component of the closing and releasing mechanism and the lock mechanism is placed at a half-latched position; and

FIG. 10C is a view for explaining the releasing operation in a condition where each component of the closing and releasing mechanism and the lock mechanism is placed at a full-latched position.

### DETAILED DESCRIPTION

An embodiment of the present invention will be explained hereinbelow with reference to the attached drawings.

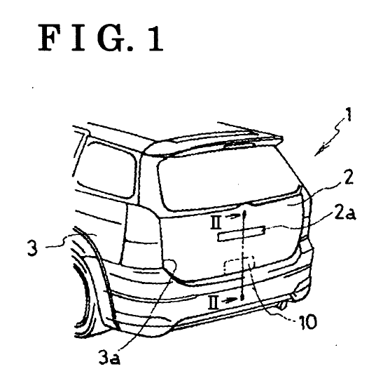

As illustrated in FIG. 1, a door 2 is provided at a rear portion of a vehicle 1. The door 2, which is a back door having a well-known structure, opens and closes an opening portion 3a formed at a vehicle body (i.e., a body 3) of the vehicle 1. A door closer apparatus 10 is provided at a lower portion of the door 2.

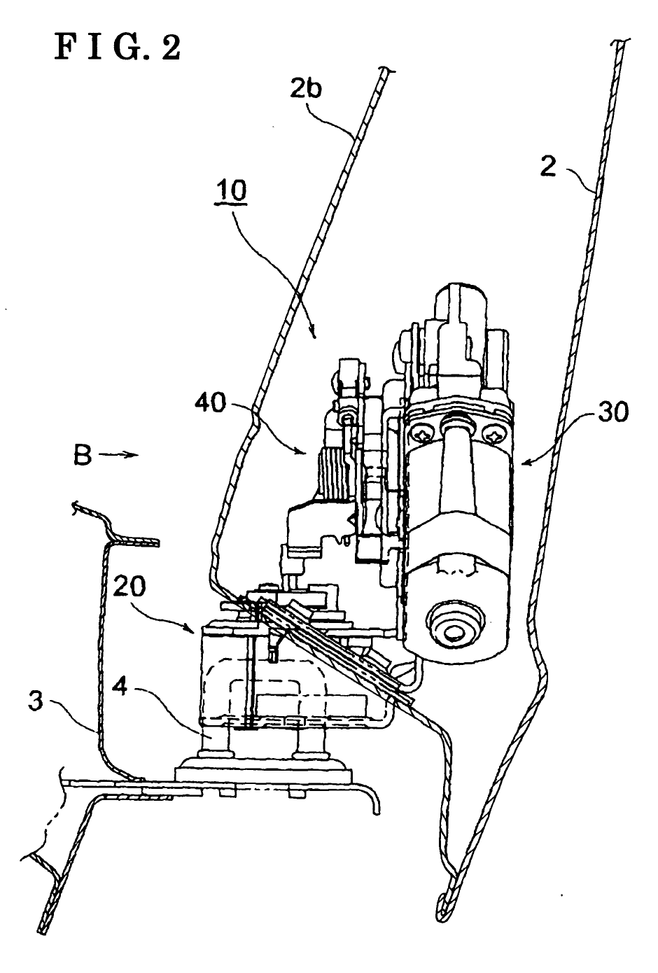

As illustrated in FIG. 2, the door closer apparatus 10 includes a lock mechanism 20, a drive unit 30, and a closing and releasing mechanism 40. The closing and releasing mechanism 40 is provided between the lock mechanism 20 and the drive unit 30. The closing and releasing mechanism 40 performs a closing operation and a releasing operation on a receipt of a driving power generated by the drive unit 30. The closing and releasing mechanism 40 is connected to the lock mechanism 20 and activates the lock mechanism 20 by performing the closing operation or the releasing operation. The closing operation and the releasing operation of the closing and releasing mechanism 40 will be described below.

The door closer apparatus 10 is provided at an interior space of the door 2 and is fixed to the door 2 by a fixing means such as a screw (not shown), or the like. The lock mechanism 20 of the door closer apparatus 10 is faced to an outside portion of the door 2 through an opening (not shown) formed at an inside panel 2b of the door 2. The lock mechanism 20 is engageable with a striker 4 fixed to an edge of the opening portion 3a of the body 3. Illustrated in FIG. 2 is a door closed state in which the lock mechanism 20 is engaged with the striker 4 and the door 2 is closed relative to the body 3.

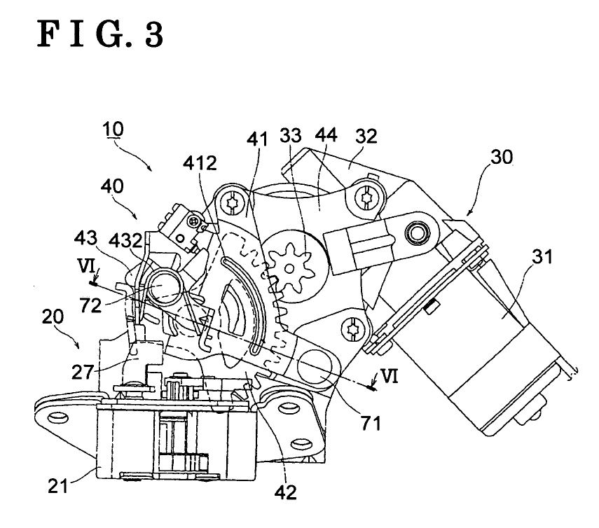

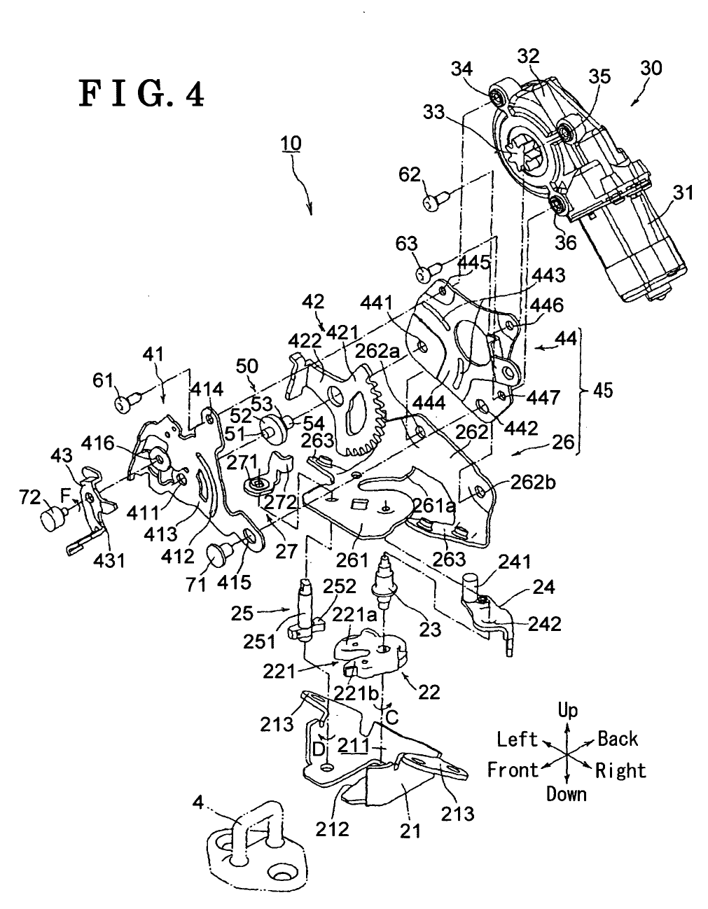

As illustrated in FIGS. 3-4, the lock mechanism 20 includes a base 21 serving as a base member, a latch 22, a latch lever 24 serving as a lever member, a pole 25, a sub base 26 serving as a first supporting member, and a lift lever 27.

The base 21, which is made of metal material, or the like, is formed into a substantial box shape. The base 21 includes a housing portion 211 and a groove portion 212. The housing portion 211 is formed into a concaved shape which opens upward. The groove portion 212 is extended in a backward and forward direction so that the striker 4 is insertable into the housing portion 211.

The latch 22 is formed of metal material, which forms a core material, and resin material, which covers the core material. The latch 22 is housed in the housing portion 211 of the base 21. The latch 22 is rotatably supported by a supporting shaft 23. The supporting shaft 23 is inserted through the latch 22 and a first end of the supporting shaft 23 is supported (connected) at the base 21. The first end of the supporting shaft 23 is engaged with the base 21 by clinching means. More particularly, the latch 22 is rotatably supported by the base 21 through the supporting shaft 23. The latch 22 is biased by means of a spring (not shown) so as to rotate in a direction of an arrow C shown in FIG. 4 around the supporting shaft 23. The latch 22 is provided with a cutout portion 221. The cutout portion 221 includes two nails 221a and 221b and is formed into a substantial U-shape. The latch 22 is engaged with the striker 4 (refer to FIG. 2) at the cutout portion 221.

The latch lever 24 is made of metal material, Or the like. A first end of the latch lever 24 is fixed to the latch 22 and a second end of the latch lever 24 supports a pin 241 serving as a rotation shaft (i.e., a curved portion). The pin 241 is formed into a substantial columnar shape. A through hole 242 is provided at the latch lever 24 between the first end and second end thereof. The supporting shaft 23 is inserted through the through hole 242. The latch lever 24 is rotatably supported by means of the supporting shaft 23. More particularly, the latch lever 24 rotates together with the latch 22 about the supporting shaft 23. The latch lever 24 is connected to a sensor (not shown). By means of the sensor, a rotation angle of the latch 22 (a position of the latch 22 relative to a reference point) is detected.

The pole 25 is formed of metal material, which forms a core material, and resin material, which covers the core material. The pole 25 includes a shaft portion 251 and an engaging portion 252. A first end of the shaft portion 251 is inserted into the base 21. The shaft portion 251 is rotatably supported by the base 21. The engaging portion 252 is integrally formed with the shaft portion 251 and rotates together with the shaft portion 251 relative to the base 21. The engaging portion 252 of the pole 25 is engaged with the nails 221a and 221b of the cutout portion 221 of the latch 22. More particularly, the pole 25 is engageable with the latch 22 in a stepwise manner at the engaging portion 252. The pole 25 is biased by means of a spring (not shown) so as to rotate in a direction of an arrow D shown in FIG. 4 about the shaft portion 251.

The sub base 26 is made of metal material, or the like. The sub base 26 is connected to the base 21 through a connect pin (not shown). The sub base 26 includes a cover portion 261 and a supporting portion 262. The cover portion 261 is formed into a substantial plate shape and covers the housing portion 211 provided at the base 21. The cover portion 261 supports a second end of the supporting shaft 23 and a second end of the shaft portion 251 of the pole 25. The second end of the supporting shaft 23 is engaged with the cover portion 261 by the clinching means. More particularly, the supporting shaft 23 connects the base 21 with the sub base 26. The base 21 and the sub base 26, which are connected with each other, are fixed to the door 2 (refer to FIG. 2) by means of a connecting member such as a screw (not shown) at fix portions 213 and 263. The second end of the shaft portion 251 of the pole 25 is inserted through the cover portion 261 and is rotatably supported by the cover portion 261. The cover portion 261 includes a cutout portion 261a. In a condition where the base 21 and the sub base 26 are connected, the housing portion 211 opens upward through the cutout portion 261a. The supporting portion 262 is integrally formed with the cover portion 261. The supporting portion 262 is bent upward relative to the cover portion 261 and is formed into a substantial plate shape. The supporting portion 262 is formed with connecting holes 262a and 262b. The supporting portion 262 forms a part of the closing and releasing mechanism 40 which will be described below.

The lift lever 27 is made of metal material, or the like. The lift lever 27 includes a shaft hole 271 and a curved surface portion 272. The second end of the shaft portion 251 of the pole 25 is inserted through the shaft hole 271. The second end of the shaft portion 251 is engaged with the lift lever 27 by the clinching means. Thereby, the lift lever 27 rotates together with the pole 25 relative to the base 21 and the sub base 26. The curved surface portion 272 is formed by means of a bending work, or the like. The curved surface portion 272 is connected to the closing and releasing mechanism 40 which will be described below.

The drive unit 30 includes a motor 31 and a speed reducing mechanism 32. The motor 31 is electrically connected to a control unit (not shown) mounted to the vehicle 1 (refer to FIG. 1). The motor 31 is applied with an electric power by means of the control unit and generates the driving power. The speed reducing mechanism 32 increases the driving power generated by the motor 31 based on a predetermined speed reducing ratio. A well-known structure with a worm and a worm wheel is applicable for the speed reducing mechanism 32. The drive unit 30 increases the driving power generated by the motor 31 at the speed reducing mechanism 32 and conclusively outputs the increased driving power as a rotation of a pinion gear 33.

The closing and releasing mechanism 40 includes a front bracket 41, a driven gear 42 serving as a rotation member, a release lever 43, and a rear bracket 44 serving as a second supporting member.

The front bracket 41 is made of metal material, or the like. The front bracket 41 includes a gear supporting hole 411 and a guide portion 412. The gear supporting hole 411 penetrates through the front bracket 41 in the backward and forward direction. The gear supporting hole 411 includes a shoulder pin 50 made of metal material, or the like. The shoulder pin 50 is coaxially provided with a front end portion 51, a larger diameter portion 52, a smaller diameter portion 53, and a rear end portion 54. The front end portion 51, the larger diameter portion 52, the smaller diameter portion 53, and the rear end portion 54 are formed into a substantial circular shape and are arranged in this order in the backward and forward direction. The larger diameter portion 52 includes a diameter (i.e., an outer diameter) larger than that of the smaller diameter portion 53. The smaller diameter portion 53 includes a diameter (i.e., an outer diameter) larger than that of the rear end portion 54. Further, the front end portion 51 includes a diameter (i.e., an outer diameter) smaller than that of the rear end portion 54. The front end portion 51 of the shoulder pin 50 is inserted into the gear supporting hole 411 of the front bracket 41. The inserted front end portion 51 of the shoulder pin 50 is engaged with the front bracket 41 by the clinching means. Thereby, the shoulder pin 50 is supported by the front bracket 41. The guide portion 412 is formed at a substantial plate shaped base portion 413 of the front bracket 41. The guide portion 412 is extended in a circumferential direction about the gear supporting hole 411. The guide portion 412 is formed by means of a press work, or the like, in such a manner that the guide portion 412 is projected rearward from the base portion 413. Further, the front bracket 41 is formed with connecting holes 414 and 415. A screw 61 is inserted through the connecting hole 414 and a connect pin 71 is inserted through the connecting hole 415.

The driven gear 42 is made of metal material, or the like.

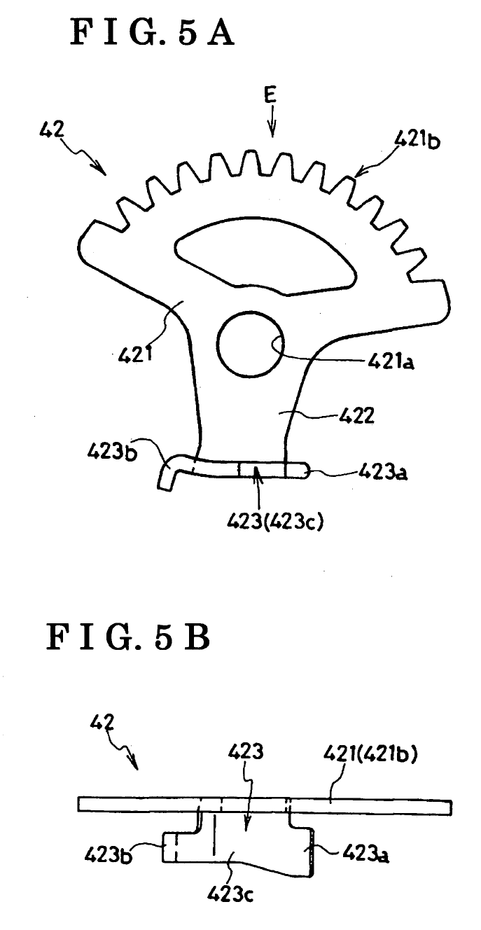

As illustrated in FIG. 5, the driven gear 42 is integrally provided with a base portion 421 and a lever portion 422 serving as a closing member. The base portion 421 is formed into a substantial fan shape. The base portion 421 includes a shaft hole 421a and a gear portion 421b. The shaft hole 421a penetrates through the base portion 421 in the backward and forward direction (i.e., a direction perpendicular to a sheet of FIG. 5). The rear end portion 54 of the shoulder pin 50 (refer to FIG. 4) is inserted through the shaft hole 421a and the smaller diameter portion 53 of the shoulder pin 50 is engaged with the shaft hole 421a. The driven gear 42 is rotatably supported by the smaller diameter portion 53 of the shoulder pin 50 around the shaft hole 421a. More particularly, the shoulder pin 50 functions as a rotation shaft of the driven gear 42. The gear portion 421b is formed at an arc portion of the base portion 421 in a circumferential direction about the shaft hole 421a. The gear portion 421b meshes with the pinion gear 33 of the drive unit 30. The base portion 421 having the gear portion 421b forms a so-called sector gear.

The lever portion 422 is formed with the base portion 421 into a single member by means of the press work, or the like. The lever portion 422 includes an engaging portion 423. The engaging portion 423 is formed by folding an end portion of the lever portion 422. The engaging portion 423 includes a closing portion 423a, a release portion 423b, and a middle portion 423c serving as a block portion. The closing portion 423a is formed at a first end of the engaging portion 423 and is engaged with the pin 241 of the latch lever 24 of the lock mechanism 20. The release portion 423b is formed at a second end of the engaging portion 423 and is engaged with the release lever 43. The middle portion 423c is formed at the engaging portion 423 between the first end and the second end thereof. The middle portion 423c is continuously formed between the closing portion 423a and the engaging portion 423.

The release lever 43 is made of metal material, or the like. The release lever 43 is formed with a shaft hole 431. A supporting pin 72 is inserted through the shaft hole 431. The supporting pin 72 inserted through the shaft hole 431 is further inserted into a lever supporting hole 416 formed at the front bracket 41 and is engaged with the front bracket 41 by the clinching means. The release lever 43 is rotatably supported by the front bracket 41 through the supporting pin 72. The release lever 43 is biased by means of a spring 432 (refer to FIG. 3) so as to rotate in a direction of an arrow F shown in FIG. 4 around the shaft hole 431. A first end of the release lever 43 is engaged with the release portion 423b of the lever portion 422 of the driven gear 42. Further, a second end of the release lever 43 is engaged with the curved surface portion 272 of the lift lever 27 of the lock mechanism 20.

The rear bracket 44 is made of metal material, or the like. The rear bracket 44 is provided with a gear supporting hole 441, a connecting hole 442, and a guide portion 443 serving as a projecting portion. The gear supporting hole 441 penetrates through the rear bracket 44 in the backward and forward direction. The gear supporting hole 441 supports the rear end portion 54 of the shoulder pin 50. The rear end portion 54 of the shoulder pin 50 is inserted through the shaft hole 421a of the driven gear 42 and is further inserted through the gear supporting hole 441 of the rear bracket 44. Then, the rear end portion 54 of the shoulder pin 50 inserted through the gear supporting hole 441 is inserted into a connecting hole 262a formed at the supporting portion 262 of the sub base 26 and is engaged with the sub base 26 (i.e., the supporting portion 262) by the clinching means. More particularly, a supporting member 45 configured of the sub base 26 and the rear bracket 44 supports the rear end portion 54 of the shoulder pin 50. Thereby, the driven gear 42 is rotatably supported by the supporting member 45 through the shoulder pin 50. Further, the cutout portion 261a formed at the cover portion 261 of the sub base 26 is placed on a rotation locus of the driven gear 42. More particularly, when the driven gear 42 is rotated, the driven gear 42 passes through at least a part of the housing portion 211 of the base 21. With such configuration, the driven gear 42 can be arranged closer to the latch 22 housed in the housing portion 211 in an upward and a downward direction, and the door closer apparatus 10 can thereby be downsized in the upward and the downward direction. The connecting hole 442 penetrates through the rear bracket 44 in the backward and forward direction as well as the gear supporting hole 441. The connect pin 71 inserted through the connecting hole 415 of the front bracket 41 is inserted through the connecting hole 442. Then, the connect pin 71 inserted through the connecting hole 442 of the rear bracket 44 is inserted into the connecting hole 262b of the supporting portion 262 of the sub base 26 and is engaged with the sub base 26 (i.e., the supporting portion 262) by the clinching means.

The guide portion 443 is formed at a substantial plate shaped base portion 444 of the rear bracket 44 and is extending in a circumferential direction around the gear supporting hole 441. Further, the guide portion 443 is formed by means of the pressing in such a manner that the guide portion 443 is protruded forward from the base portion 444.

The rear bracket 44 further includes connecting holes 445-447. The screw 61, inserted through the connecting hole 414 of the front bracket 41, is inserted through the connecting hole 445. A screw 62 is inserted through the connecting hole 446 and a screw 63 is inserted through the connecting hole 447. The screw 61, inserted through the connecting hole 445, is screwed into a screw hole 34, the screw 62, inserted through the connecting hole 446, is screwed into a screw hole 35, and the screw 63, inserted through the connecting hole 447, is screwed into a screw hole 36. Thereby, the drive unit 30 is supported by the rear bracket 44 and the pinion gear 33 of the drive unit 30 is meshed with a gear portion 421b of the driven gear 42.

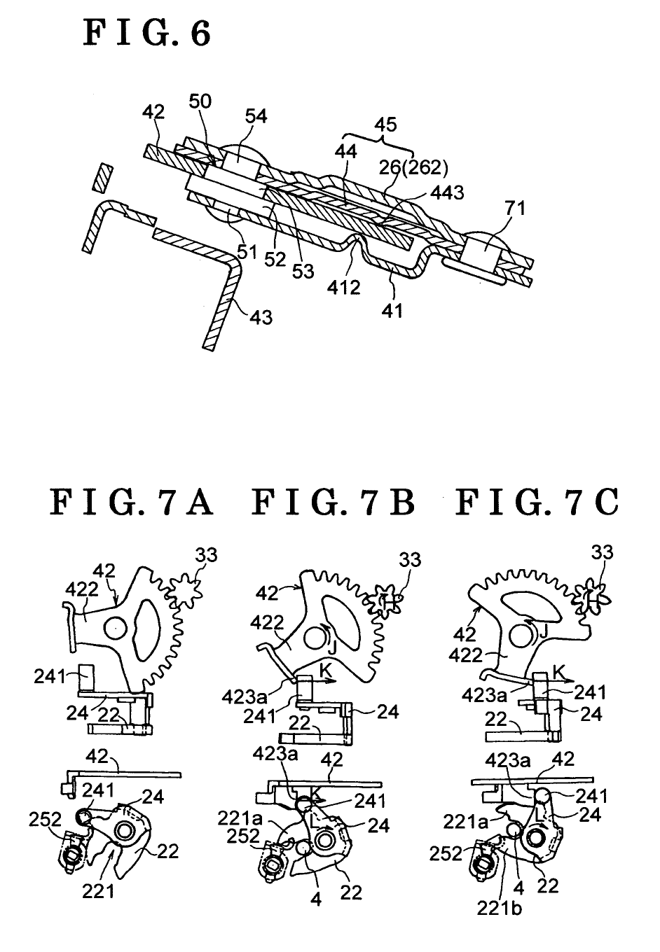

As illustrated in FIG. 6, the supporting member 45 formed of the sub base 26 and the rear bracket 44 supports the rear end portion 54 of the shoulder pin 50. The front bracket 41 supports the front end portion 51 of the shoulder pin 50. The driven gear 42 is rotatably supported by the smaller diameter portion 53 of the shoulder pin 50. More particularly, the shoulder pin 50 serving as the rotation shaft of the driven gear 42 is supported at both ends thereof and the driven gear 42 is rotated between the supporting member 45 and the front bracket 41. With such configuration, support strength of the shoulder pin 50 is increased and a position of the driven gear 42 is restricted in an axial direction of the shoulder pin 50 (i.e., an up and down direction in FIG. 6). Further, because the supporting member 45 and the front bracket 41 are connected through the connect pin 71, a position of the shoulder pin 50 supported by the supporting member 45 and the front bracket 41 is settled and the support strength of the shoulder pin 50 is further increased. Accordingly, even in a condition where the driven gear 42 is applied with a large load in the axial direction of the shoulder pin 50, the rotation shaft (i.e., the shoulder pin 50) of the driven gear 42 is not inclined and the driven gear 42 can smoothly be rotated. According to the embodiment of the present invention, because the larger diameter portion 52 of the shoulder pin 50 is interposed between the front bracket 41 and the driven gear 42, the support strength of the rotation shaft of the driven gear 42 is further increased. Further, a rotation of the driven gear 42 is guided by the guide portion 443 formed at the rear bracket 44 of the supporting member 45 and the guide portion 412 formed at the front bracket 41. The guide portions 412 and 443 are contactable with the driven gear 42 in the axial direction of the shoulder pin 50. More particularly, the guide portions 412 and 443 restrict the position of the driven gear 42 in the axial direction of the shoulder pin 50 by contacting the driven gear 42. Each end portion of the guide portions 412 and 443 (i.e. each part to be contacted by the driven gear 42) is formed into a curved surface. By means of the guide portions 412 and 443, the driven gear 42 can smoothly be rotated.

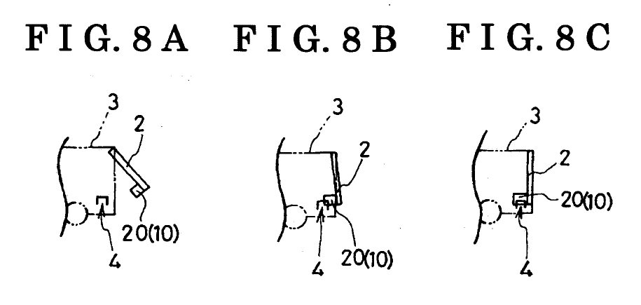

The closing and releasing operations of the closing and releasing mechanism 40 will be described hereinafter with reference to FIGS. 7A-10C. The closing operation is performed when the door 2 is closed from a door opened state shown in FIG. 8A in which the door 2 is opened relative to the body 3. In a condition where the door 2 is in the door opened state, each component of the closing and releasing mechanism 40 and the lock mechanism 20 is placed at an initial position shown in FIG. 7A

When the door 2 is moved in a closing direction from the door opened state, the lock mechanism 20 fixed to the door 2 approaches the striker 4 fixed to the body 3 and the cutout portion 221 of the latch 22 of the lock mechanism 20 is engaged with the striker 4. Then, when the door 2 is further moved, each component of the closing and releasing mechanism 40 and the lock mechanism 20 is moved to a half-latched position shown in FIG. 7B in which the engaging portion 252 of the pole 25 is engaged with the nail 221a of the cutout portion 221 of the latch 22. The drive unit 30 begins to be activated a little while before the latch 22 reaches the half-latched position. When the pinion gear 33 of the drive unit 30 is rotated in a direction of an arrow H, the driven gear 42 meshed with the pinion gear 33 is rotated in a direction of an arrow J and the lever portion 422 (the closing portion 423a) of the driven gear 42 is in contact with the pin 241 of the latch lever 24 in a direction of an arrow K as illustrated in FIG. 7B. At this stage, the door 2 is not fully closed relative to the body 3 as illustrated in FIG. 8B.

When the driven gear 42 is further rotated on a receipt of the driving power from the pinion gear 33, the pin 241 of the latch lever 24 is pushed in the direction of the arrow K (i.e., a first direction) through the closing portion 423a. During this operation, the closing portion 423a of the driven gear 42 is slidably in contact with the pin 241 of the latch lever 24. Because the pin 241 of the latch lever 24 is formed into a substantial columnar shape, the closing portion 423a (the lever portion 422) of the driven gear 42 is in contact with the pin 241 of the latch lever 24 by a line (line contact). Thereby, friction generated between the lever portion 422 of the driven gear 42 and the pin 241 of the latch lever 24 can be reduced relative to a condition in which the lever portion 422 is in contact with the pin 241 by a surface.

When the lever portion 422 of the driven gear 42 pushes the pin 241 of the latch lever 24, the latch lever 24 is rotated in a direction of an arrow L (the closing direction) and the latch 22 engaged with the striker 4 is also rotated in a same direction (the closing direction). Then, the each component of the closing and releasing mechanism 40 and the lock mechanism 20 is moved to a full-latched position as shown in FIG. 7C in which the engaging portion 252 of the pole 25 is engaged with the nail 221b of the cutout portion 221 of the latch 22. At this stage, the door 2 comes into a door closed state in which the door 2 is fully closed relative to the body 3.

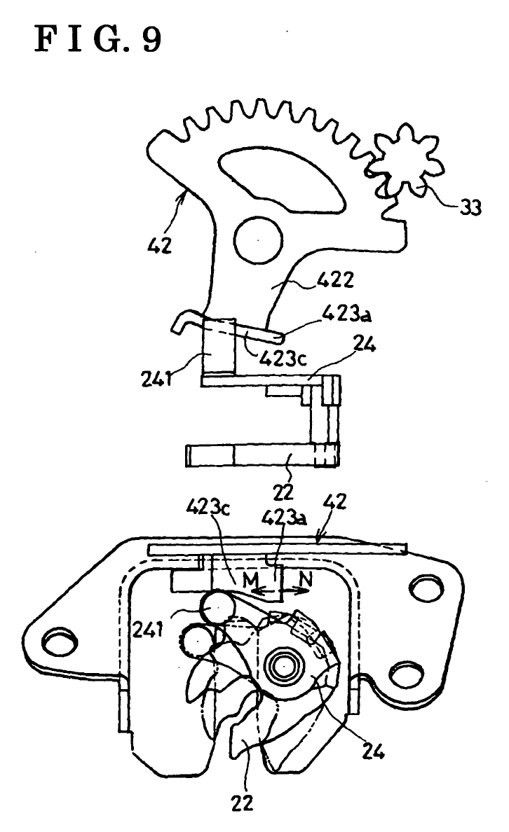

There is a time lag between a timing in which the drive unit 30 begins to be activated and a timing in which the latch 22 reaches the half-latched position during the closing operation. If the door 2 is moved in an opening direction to make the door 2 into the door opened state (i.e., if an irregular operation is performed) during this time lag, the latch 22 and the latch lever 24 are moved to a position indicated by a chin double-dashed line in FIG. 9. On this occasion, the driven gear 42 reaches the full-latched position shown in FIG. 9 without engaging with the latch lever 24. After the irregular operation is performed, when the door 2 is moved again to the closing direction, the cutout portion 221 of the latch 22 is engaged with the striker 4 and the latch 22 and the latch lever 24 are moved to a position indicated by a full line in FIG. 9. On this occasion, because the latch lever 24 is in contact with the middle portion 423c of the lever portion 422 of the driven gear 42, a further rotation of the latch lever 24 is restricted and the latch 22 and the latch lever 24 are not reached to the half-latched position shown in FIG. 7B. Because of its structure, the closing portion 423a of the lever portion 422 of the driven gear 42 cannot push the lath lever 24 (the pin 241) in a direction of an arrow M in FIG. 9 (i.e., a second direction). More particularly, the closing portion 423a of the driven gear 42 pushes the latch lever 24 only in a direction of an arrow N (i.e., the first direction) in FIG. 9 which is corresponding to the direction of the arrow K in FIG. 7B. Because the latch lever 24 is not reached to the half-latched position, the latch lever 24, the operation of which is restricted, is not pushed by the lever portion 422 of the driven gear 42 in the direction of the arrow M. Accordingly, a reliable operation of the door closer apparatus 10 can be ensured.

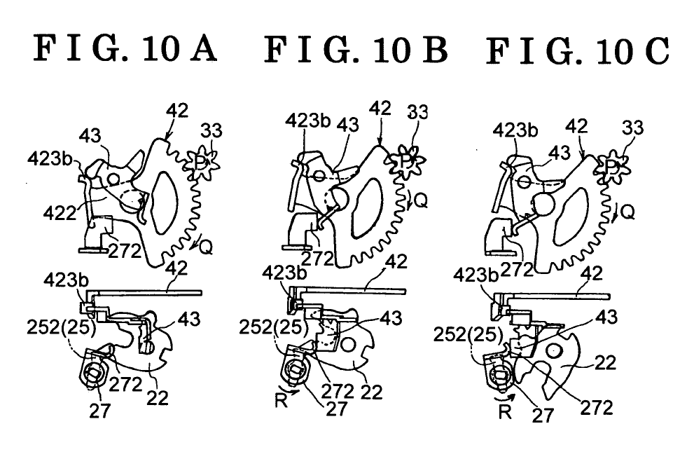

The releasing operation is performed when the door 2 is opened from the door closed state shown in FIG. 8C in which the door 2 is closed relative to the body 3. In a condition where the door 2 is in the door closed state, each component of the closing and releasing mechanism 40 and the lock mechanism 20 is placed at an initial position shown in FIG. 10A.

When the drive unit 30 begins to be activated in response to an operation of a switch (not shown), or the like, provided at a handle 2a of the door 2, the pinion gear 33 of the drive unit 30 is rotated in a direction of an arrow P and the driven gear 42 is rotated in a direction of an arrow Q. When the driven gear 42 is rotated, the release lever 43 engaged with the lever portion 422 (release portion 423b) of the driven gear 42 rotates and the release lever 43 comes in contact with the curved surface portion 272 of the lift lever 27 as illustrated in FIG. 10B.

When the driven gear 42 is further rotated on a receipt of the driving power from the pinion gear 33, the lift lever 27 is pushed through the release portion 423b of the lever portion 422. In accordance with the rotation of the driven gear 42, the pole 25 engaged with the lift lever 27 is rotated in a direction of an arrow R and the engaging portion 252 of the pole 25 is released from the latch 22 as illustrated in FIG. 10C. At this stage, the door 2 comes into the door opened state in which the door 2 is opened relative to the body 3 shown in FIG. 5A.

According to the embodiment of the present invention, the door closer apparatus 10 is provided at the door 2 and the striker 4 is provided at the body 3. However, the present invention is not limited thereto. Alternatively, or in addition, the door closer apparatus 10 may be provided at the body 3 and the striker 4 may be provided at the door 2.

According to the embodiment of the present invention, the driven gear 42 is integrally provided with the base portion 421 including the gear portion 421b and the lever portion 422. However, the present invention is not limited thereto. Alternatively, or in addition, the base portion 421 including the gear portion 421b and the lever portion 422 may separately be formed and may be fixed with each other by means of welding, or the like.

According to the embodiment of the present invention, the pin 241 of the latch lever 24 slidably in contact with the lever portion 422 (the closing portion 423a) of the driven gear 42 is formed into a substantial columnar shape. However the present invention is not limited thereto. Alternatively, or in addition, the lever portion 422 (the closing portion 423a) may include a curved surface.

According to the embodiment of the present invention, the latch 22 and the latch lever 24 are separately provided. However, the present invention is not limited thereto. The latch 22 and the latch lever 24 may integrally be provided.

According to the embodiment of the present invention, the supporting member 45, which supports an end of the rotation shaft of the driven gear 42, is configured of two components such as the sub base 26 and the rear bracket 44. However, the present invention is not limited thereto. Alternatively, or in addition, the supporting member 45 may be configured of one component which is made by forming the base 26 and the rear bracket 44 into a single member by means of the pressing.

According to the embodiment of the present invention, the guide portion 443 is formed at the rear bracket 44 of the supporting member 45 and the guide portion 412 is formed at the front bracket 41. However, the present invention is not limited thereto. Alternatively, or in addition, a structure corresponding to the guide portion 443 (412) may be provided at at least one of the rear bracket 44 and the front bracket 41.

With the configuration of the door closer apparatus 10 according to the embodiment of the present invention, the lever portion 422 for rotating the latch 22 is integrally provided with the driven gear 42. With this configuration, the driving power generated by the motor 31 can be transmitted to the latch lever 24 (latch 22) through the driven gear 42 with minimum loss. Therefore, transmission efficiency of the driving power at the door closer apparatus 10 can be improved.

With the configuration of the door closer apparatus 10 according to the embodiment of the present invention, the closing portion 423a of the lever portion 422 does not push the latch lever 24 (the pin 241) in the direction of the arrow M in FIG. 9 because of the middle portion 423c provided at the lever portion 422. More particularly, the lever portion 422 pushes the latch lever 24 only in the direction of the arrow N in FIG. 9 which is corresponding to the direction of the arrow K in FIG. 7B. Therefore, the latch 22 is reliably rotated in the direction of the arrow L in FIG. 7C and the operation of the door closer apparatus 10 can thereby be stabilized.

With the configuration of the door closer apparatus 10 according to the embodiment of the present invention, the lever portion 422 pushes the latch lever 24 through the substantial column shaped pin 241. When the lever portion 422 pushes the latch lever 24 for rotating the latch 22, the lever portion 422 and the latch lever 24 are slidably in contact with each other. Because of the substantial column shaped pin 241, the friction generated between the lever portion 422 and the latch lever 24 can be reduced and the driving power can smoothly be transmitted between the lever portion 422 and the latch lever 24.

With the configuration of the door closer apparatus 10 according to the embodiment of the present invention, the lever portion 422 is integrally formed with the driven gear 42 by means of the pressing. Therefore, strength of the whole driven gear 42, which is integrally provided with the lever portion 422, can be improved and a manufacturing cost thereof can be reduced.

According to the embodiment of the present invention, the closing member for rotating the latch in the closing direction is integrally formed with the rotation member. Therefore, the driving power can be transmitted from the rotation member to the closing member with minimum loss. Accordingly, the transmission efficiency of the driving power in the door closer apparatus can be improved.

According to the embodiment of the present invention, because of the block portion provided at the closing member, the closing member does not push the lever member in the second direction. More particularly, the closing member pushes the lever member only in the first direction. Accordingly, the latch can reliably be rotated in the closing direction and the operation of the door closer apparatus can be stabilized.

According to the embodiment of the present invention, the closing member pushes the lever member through the curved portion. When the closing member pushes the lever member for rotating the latch, the closing member and the lever member are slidably in contact with each other. Because of the curved portion, the friction generated between the closing member and the lever member can be reduced and the driving power can smoothly be transmitted from the closing member to the lever member.

According to the embodiment of the present invention, the closing member is integrally formed with the rotation member by means of the pressing. Therefore, strength of the integrally formed closing member and the rotation member can be improved and the manufacturing cost thereof can be reduced.

The principles, preferred embodiment and mode of operation of the present invention have been described in the foregoing specification. However, the invention which is intended to be protected is not to be construed as limited to the particular embodiment disclosed. Further, the embodiment described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A door closer apparatus for a vehicle, comprising:
a striker provided at one of a vehicle body and a door;
a latch provided at the other one of the vehicle body and the door, the latch being engageable with the striker;
a motor configured to apply a driving power to the latch, the motor being configured to rotate the latch in engaged with the striker in a closing direction by applying the driving power, so as to control the door to a closed state relative to the vehicle body;
a rotation member provided between the motor and the latch for transmitting the driving power to the latch;
a lever member integrally rotated with the latch; and
a closing member integrally formed with the rotation member, the closing member being configured to push the lever member in a first direction for rotating the latch in the closing direction.

2. The door closer apparatus for a vehicle according to claim 1, further comprising
a block portion which is provided at the closing member and prevents the closing member from pushing the lever member in a second direction.

3. The door closer apparatus for a vehicle according to claim 2, further comprising
a curved portion provided at at least one of the lever member and the closing member, wherein the closing member pushes the lever member through the curved portion.

4. The door closer apparatus for a vehicle according to claim 3, wherein the closing member is integrally formed with the rotation member by means of a pressing.

5. The door closer apparatus for a vehicle according to claim 1, further comprising
an engaging portion formed by folding, an end of the closing member.

6. The door closer apparatus for a vehicle according to claim 5, further comprising
a closing portion formed at a first end of the engaging portion;
a release portion formed at a second end of the engaging portion; and
a middle portion continuously formed between the closing portion and release portion.

7. The door closer apparatus for a vehicle according to claim 3, wherein the curved portion includes a column shaped pin.

8. The door closer apparatus for a vehicle according to claim 7, wherein the pin and the closing portion are slidably in contact with each other.

9. The door closer apparatus for a vehicle according to claim 1, wherein the closing member and the lever member are slidably in contact with each other.

10. The door closer apparatus for a vehicle according to claim 1, wherein the rotation member includes a driven gear.

11. The door closer apparatus for a vehicle according to claim 1, wherein the closing member includes a curved surface.

12. The door closer apparatus for a vehicle according to claim 1, wherein the latch and the lever member are formed into a single member.

13. The door closer apparatus for a vehicle according to claim 1, wherein the rotation member is made by integrally forming a driven gear shaped base portion and the closing member into a single member.
